(19) United States
(12) Patent Application Publication
(10) Pub. No.: US 2005/0067509 A1
(43) Pub. Date: Mar. 31, 2005

(54) Device for the multi-directional delivery of fluids

(75) Inventor: Tiziano Redaelli, Busto Arsizio (VA) (IT)

Correspondence Address: THE FIRM OF KARL F ROSS, 5676 RIVERDALE AVENUE, PO BOX 900, RIVERDALE (BRONX), NY, 10471-0900, US

(73) Assignee: SOLCHIM S.P.A.

(21) Appl. No.: 10/839,475

(22) Filed: May 5, 2004

(30) Foreign Application Priority Data
Sep. 30, 2003 (IT) MI2003U000448

(51) Int. Cl. A61M 5/30; A61M 5/20; B05B 9/03

(52) U.S. Cl. 239/548; 239/302; 239/337

(57) ABSTRACT

Device for the delivery of pressurised fluids contained in a container (20), comprising at least two delivery apertures (12;112;212), the longitudinal axis (Z-Z) of which forms an angle (α) with a reference axis of the said device.

### DESCRIPTION

The present invention relates to a multi-directional delivery device for fluids stored in pressurised containers.

In the art spray cans are known, said cans containing a fluid which is partially in a gaseous state so as to produce a pressure and form a propellant which allows delivery of the fluid by means of delivery devices mounted on the can.

It is also known that said spray cans are able to emit a single mono-directional jet of fluid.

The technical problem which is posed, therefore, is that of designing a device for delivering a fluid, which is able to emit a plurality of jets in different directions.

In connection with this problem it is also required that said device should have small dimensions, should be easy and inexpensive to produce and be suitable for use also by non-expert end users.

These results are achieved according to the present invention by a device for the delivery of pressurised fluids contained inside a container, comprising at least two delivery apertures, the longitudinal axis of which forms a relative angle α with a reference axis of the said device.

Further details may be obtained from the following description of a non-limiting example of embodiment of the subject of the present invention provided with reference to the accompanying drawings in which:

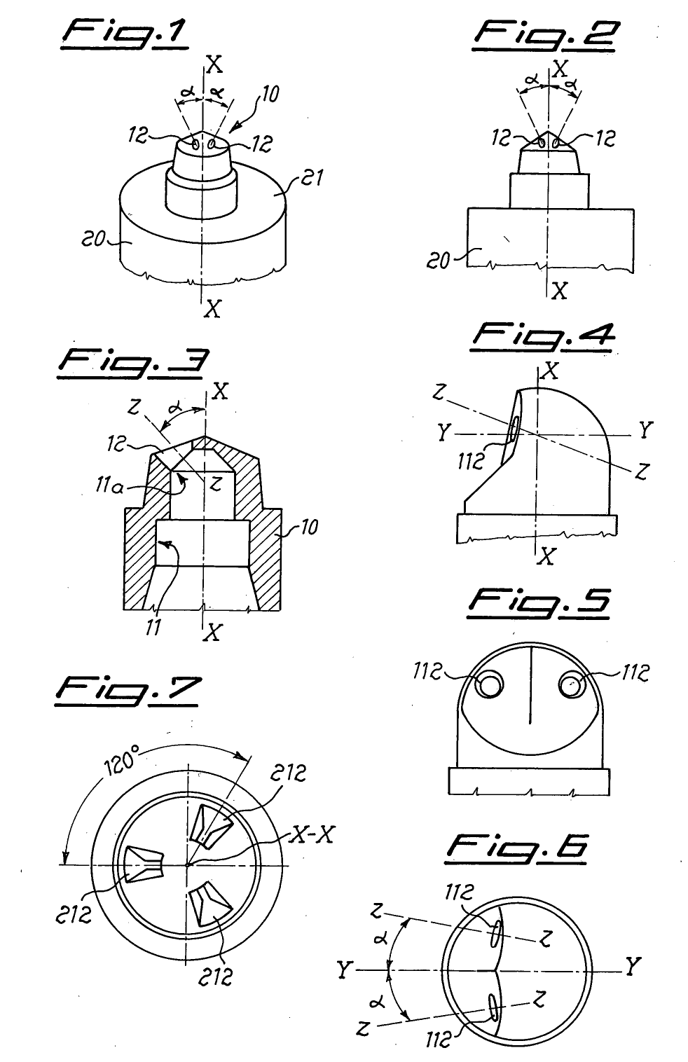

FIG. 1 shows a perspective view, from above, of the delivery device according to the present invention;

FIG. 2 shows a side view of the device according to FIG. 1;

FIG. 3 shows a schematic cross-sectional view of the device according to FIG. 1 along an axial vertical plane;

FIG. 4 shows a side view of a first example of embodiment by way of variation of the device according to the present invention;

FIG. 5 shows a front view of the device according to FIG. 4;

FIG. 6 shows a schematic top plan view of the device according to FIG. 4;

FIG. 7 shows a schematic top plan view of a second example of embodiment by way of variation of the device according to FIG. 1.

As shown in FIGS. 1-3, the device according to the present invention is formed by a substantially cylindrical body 10 which is internally hollow and shaped with a profile 11 able to be mounted on the suitably designed top part 21 of a spray can 20 containing a fluid with propellant under pressure.

Since said arrangement is per se conventional, it is not illustrated nor described in detail.

The top part 11a of the device is also designed to contain the needle (not shown) for opening the fluid delivery valve.

In the top part 11a of the device there are also formed at least two apertures 12, the longitudinal axis Z-Z of which is inclined at an angle α with respect to the longitudinal axis X-X of the said device.

According to the invention it is envisaged that said angle α has an amplitude of between 8° and 85° and preferably between 13.5° and 50°.

As shown in FIGS. 4-6, the delivery device according to the invention may also be designed with a delivery substantially oriented along an axis Y-Y perpendicular to the longitudinal axis X-X of the said device; in this case also, it is envisaged that the longitudinal axes Z-Z of the delivery apertures 112 are inclined at an angle α with respect to the said perpendicular axis Y-Y; the amplitude of the said angle α ranging between 8° and 85° and preferably between 13.5° and 50°.

As shown in FIG. 7, it is also envisaged that the device may have a plurality (three in the example shown) of delivery apertures 212 which are arranged at a constant relative angular distance; in the example showing three apertures this angular distance is 120°; in this case also the angle α between the longitudinal axis Z-Z of the delivery apertures and the longitudinal axis X-X of the device is kept within the abovementioned values.

It is therefore obvious how the device according to the invention is able to deliver several jets of fluid in directions able to produce an effective cloud of fluid which is not dispersed or excessively concentrated upon being released into the atmosphere.

This solution is particularly effective for those fluids which, upon leaving the spray can, solidify in a string-like form or the like.

1. Device for the delivery of pressurised fluids contained in a container (20), characterized in that it has at least two delivery apertures (12;112;212), the longitudinal axis (Z-Z) of which forms an angle (α) with a reference axis of the said device.

2. Device according to claim 1, characterized in that said angle (α) has an amplitude of between 8° and 85°.

3. Device according to claim 2, characterized in that said angle (α) has an amplitude preferably of between 13.5° and 50°.

4. Device according to claim 1, characterized in that said reference axis is the longitudinal axis (X-X) of the device.

5. Device according to claim 1, characterized in that said reference axis is an axis (Y-Y) perpendicular to the longitudinal axis (X-X) of the device.

6. Device according to claim 1, characterized in that it has a plurality of delivery apertures (212) mutually arranged at a constant angular distance.

7. Device according to claim 6, characterized in that it has three delivery apertures (212) mutually arranged at a relative angular distance of 120°.
